(19) United States
(12) Patent Application Publication
(10) Pub. No.: US 2008/0270425 A1
(43) Pub. Date: Oct. 30, 2008

(54) System and method for connecting individuals in a social networking environment based on facial recognition software

(76) Inventor: James Cotgreave, Smithtown, NY (US)

Correspondence Address: Thomas M. Galgano, Esq.;GALGANO & ASSOCIATES, PLLC, Suite 204, 20 W. Park Avenue, Long Beach, NY, 11561, US

(21) Appl. No.: 11/899,220

(22) Filed: Sep. 5, 2007

Related U.S. Application Data
(60) Provisional application No. 60/926,442, filed on Apr. 27, 2007.

(51) Int. Cl. G06F 17/30

(52) U.S. Cl. 707/100; 707/E17.005

(57) ABSTRACT

A social networking system uses facial recognition software to match members. A first member may choose to search for other members who look like the first member or may search for members who look like a third party. The invention is implemented on the internet and allows members to upload personal information as well as photos to be used in match searches. The system also includes all or most of the features of existing internet social networking systems.

### RELATED APPLICATION

This application claims the benefit of U.S. Provisional Application No. 60/926,442 filed Apr. 27, 2007.

### BACKGROUND OF THE INVENTION

1. Field of the Invention

This invention relates broadly to social networking methods. More particularly, this invention relates to social networking systems which match individuals through the use of facial recognition software.

2. State of the Art

Social networking is a term used to describe the process by which an individual discovers and maintains relationships with other individuals. Everyone is born with a pre-defined social network, i.e. their family. As an infant ages into childhood, the child develops another social network, i.e. playmates. This is followed by schoolmates, co-workers, and business contacts. Traditionally, social networks are created by one person introducing someone to another person. To facilitate such introductions, a person can become a member of a group such as a club where people with similar interests meet on a regular or irregular basis. Social networking techniques are also often used to find a mate or marriage partner.

Since the widespread acceptance of the internet there have arisen a number of successful social networking websites. The basic methods employed by these services include allowing a member to post some information about themselves, allowing other members access to that information, and providing a means by which members may exchange messages. Most of these services also provide means by which a member can maintain a list of friends or contacts and means by which that list can be viewed by others.

Some social networking websites are geared toward a common interest such as photography. Photography social networking sites permit members to maintain a portfolio of photographs which other members can view and post comments about.

Some social networking sites automatically match members according to questionnaire answers. These sites are typically geared toward matching people for dating, romance, or marriage purposes.

### SUMMARY OF THE INVENTION

It is therefore an object of the invention to provide a new type of social networking service.

It is another object of the invention to provide a social networking service which automatically matches members or suggests member matches.

In accord with these objects, which will be discussed in detail below, the present invention provides a social networking service which includes many of the features of existing social networking services such as collecting profile data from members, allowing members to view other member's profiles, allowing members to send each other messages, and automatically matching members or suggesting matches according to their profiles. According to one aspect of the invention, members upload photographs of themselves as part of their profile and facial recognition software is used to automatically match members or to suggest matches to members. According to a first embodiment of the invention, members are matched (or matches are suggested) according to how much they look like each other. For example a member seeking a match will be automatically provided with a list of other members who look like the member seeking the match. According to a second embodiment of the invention, a member may seek other members who look like some third person, e.g. a celebrity. Men can seek women who look like Angelina Jolie and women can seek men who look like Brad Pitt, for example. Other matching scenarios are possible according to the invention. For example, a member may upload a photograph of a former mate or family member and seek other members who look like the person in the uploaded photograph.

According to the invention, the social networking service is provided via the internet. Therefore, the systems for performing the methods of the invention include at least one server, preferably several servers with a load balancer, coupled to the internet. The at least one server includes a web pages server, database management software, database storage, a messaging server, message storage, and facial recognition software. Members and potential members access the service via a web browser running on a computer or other web access device (such as a cell phone or other web enabled device) by entering a URL (uniform resource locator, also known as a web address).

New members are prompted to establish an account with a member name and a password, enter profile data and upload one or more photos. Digital cameras are now ubiquitous. Some computers come equipped with built-in cameras. Most cell phones include digital cameras and dedicated still and motion digital cameras are now relatively inexpensive. Therefore, it is easy for members and potential members to provide digital photographs for uploading. The member name, password, profile data, and photograph(s) are stored in the database. Facial recognition software identifies “nodal points” such as the distance between the eyes, the width of the nose, the shape of the cheekbones, the length of the jaw line, etc. These nodal points are measured and a numeric code called a “faceprint” is stored in the database and linked to the photo and the member information.

Once a member has created an account, uploaded a photograph and created a profile, the member can search for other members who match according to profile and/or according to faceprint. The numerical faceprints are compared and the comparison is scored, e.g. from 0% to 100% match. Before matching faceprints, the member selects the number of matches desired, e.g. ten. The software then compares faceprints and returns the ten best matching photographs and profiles which are displayed in a web page. The photos may be hot linked to the corresponding member's message address.

Upon viewing the match results, the member may then browse the profiles of the matching members and may contact a matching member via the messaging system (email, instant message, or both). If desired, the member can continue to browse lower ranked matches, e.g. the next ten.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level block diagram of a system according to the invention;

FIG. 2 is an exemplary graphical interface for creating a member account and profile;

FIG. 3 is an exemplary graphical interface for uploading photos;

FIG. 4 is a high level flow chart illustrating the steps in associating photos with a member profile;

FIG. 5 is an exemplary profile screen;

FIG. 6 is an exemplary graphical interface for entering search criteria;

FIG. 7 is a high level flow chart illustrating the matching of member profiles to search criteria;

FIG. 8 is an exemplary display of an array of matching members; and

FIG. 9 is a high level flowchart illustrating alternate ways to find matching members.

### DETAILED DESCRIPTION

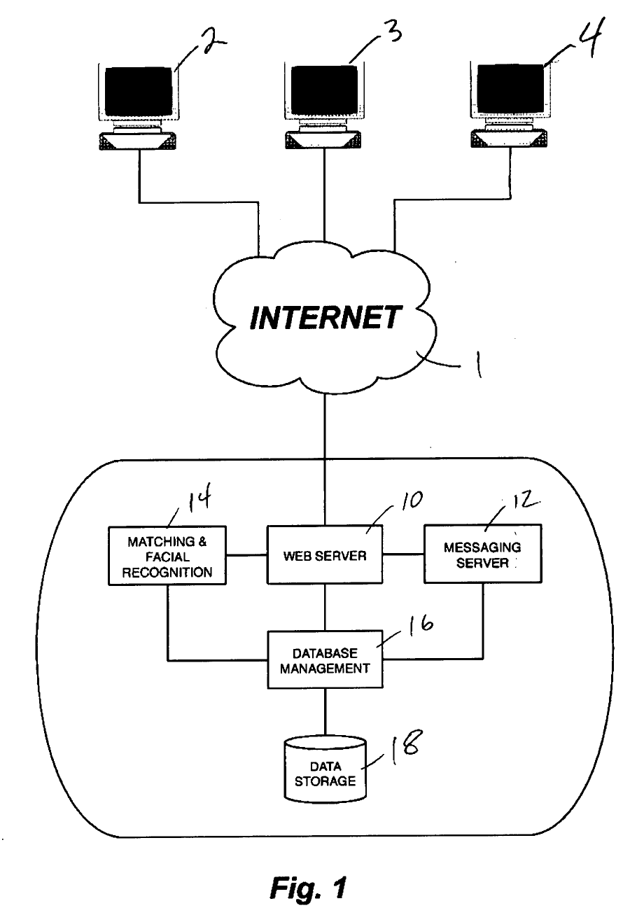

Turning now to FIG. 1, a social networking system according to the invention includes a web server 10 coupled to the internet 1. The web server 10 is also coupled to a messaging server 12, matching and facial recognition software 14, and database management software 16. The database management software 16 communicates with data storage 18 and provides information to the matching and facial recognition software 14 as well as the web server 10. The messaging server 12 stores and retrieves messages in the data storage 18 via the database management software 16. As illustrated in FIG. 1, a plurality of member computers (or internet devices), e.g. 2, 3, 4, connect to the system via the internet 1. The system illustrated in FIG. 1 is greatly simplified. Those skilled in the art will appreciated that the web server in a large system will likely comprise many web servers which are selected via a load balancer depending on the number of members being logged on at the same time.

According to the presently preferred embodiment, the database management software is Microsoft SQL Server 2005 Enterprise Edition, the web server runs code developed with Adobe Cold Fusion 8 Enterprise, the web server software is Internet Information. Services (IIS) which is part of Windows Server 2003, and the facial recognition software is Verilook 3.0 from Neurotechnologija, Vilnius, Lithuania. Those skilled in the art will appreciate, however, that other database, web, and facial recognition software could be used.

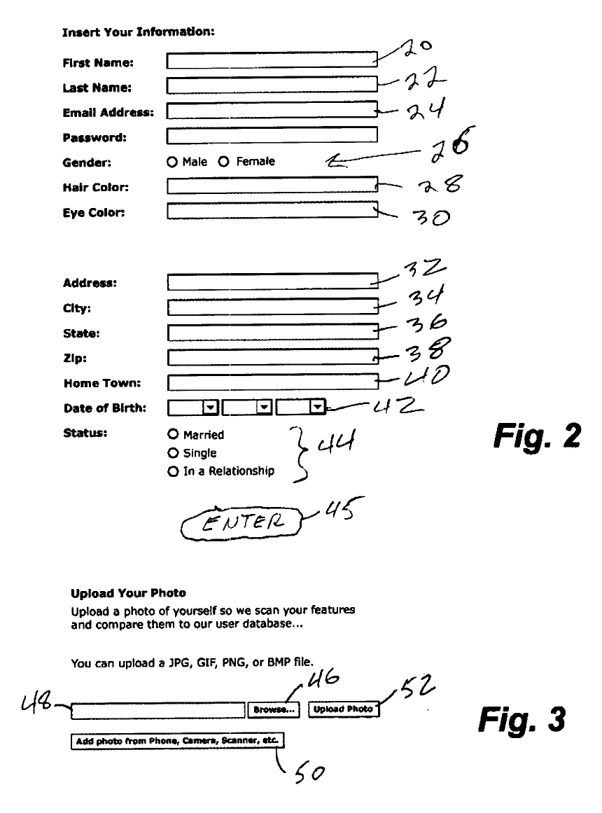

According to the methods of the invention, potential members of the system create an account and enter some personal information into a profile. FIG. 2 illustrates a sample entry screen for creating an account and entering some personal information. Fields 20 and 22 require the new member to type in their first and last name. Email address is entered in field 24. Field 25 is provided for the member to enter the desired password to their account. “Radio buttons” 26 are provided for the member to indicate gender. Some personal information such as hair color and eye color are entered in fields 28 and 30. The member's street address is entered in field 32, city in field 34, state in field 36, and zip code in field 38. In the illustrated example, a field is provided at 40 for “home town”. Date of birth is entered via three pull down lists at 42, one for month, one for day, and one for year. Three radio buttons are provided at 44 to indicate whether the member is married, single, or in a relationship. When all of the fields have been filled and radio buttons selected, the member mouse clicks on the ENTER button 45. The entry form of FIG. 2 is merely exemplary and many other fields could be provided such as hobbies, favorite sports, favorite teams, favorite foods, favorite types of music, etc.

Turning now to FIG. 3, after the member enters their profile information, the user is prompted to upload one or more photos. The interface for uploading photos includes one text field 48 and three buttons 46, 50, and 52. Mouse clicking on button 46 causes an open file dialog box to appear where the member can browse the contents of their computer's hard drive to locate an image file to upload. When the file is selected, the path to it is displayed in the text field 48. If the correct file appears, the member uploads it by mouse clicking on the button 52. If an incorrect file appears in the text field, the user can delete the text and try again. Button 50 allows the member to select an image file from an external device such as a phone, a camera, or a scanner. Mouse clicking on button 50 will present a dialog box listing all the external devices which are in communication with the member's computer either by wired or wireless connection. Selecting the device will then present an appropriate dialog box for the selected device. Though not shown in FIG. 3, the interface preferably includes a means of identifying photos other than by pathname. For example, it is required that the first photo upload be named ME and that it be a photo of the member. Subsequent uploads may be given any name the member chooses, e.g. MOM, ANGELINA, BRAD, name of old girlfriend, etc.

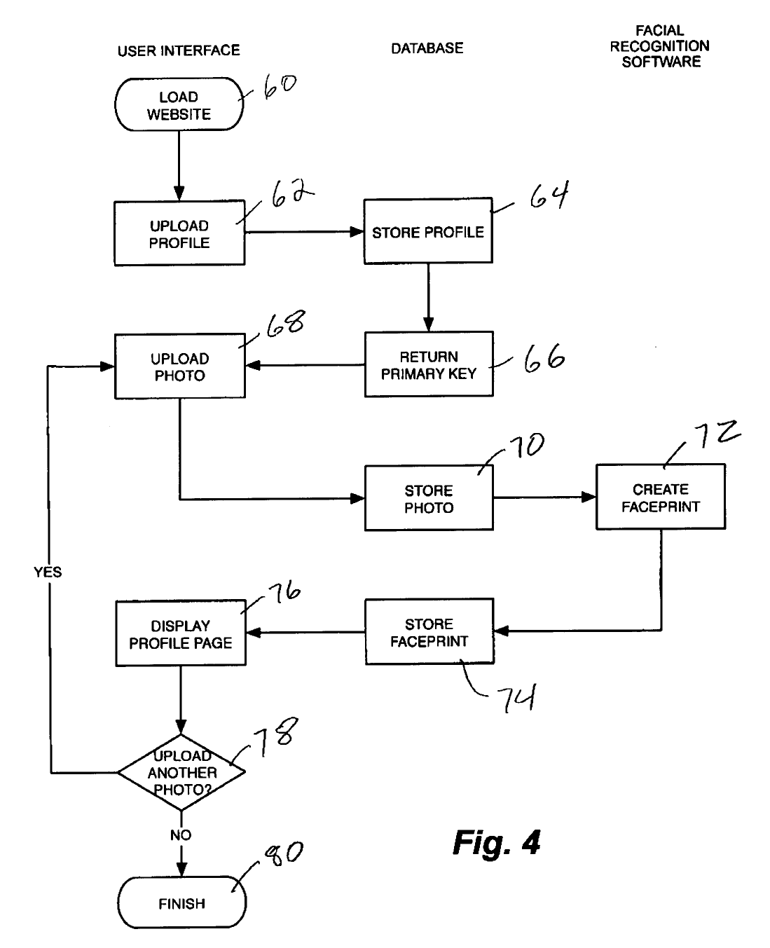

FIG. 4 illustrates the interactive operations which occur during registration and uploading photos. The processes are divided into three categories: the user interface, database operations, and facial recognition software operations. When the potential member enters the correct URL, a portion of the website is loaded onto the member's computer at 60. After selecting an option to register, the member is presented with the interface shown in FIG. 2. When the member mouse clicks on the enter button (45 in FIG. 2), the profile is uploaded at 62. The database software receives the profile data, stores it at 64, and generates a unique “primary key” at 66 which identifies the member's profile. When the member uploads a photo at 68, the database stores the photo at 70 and links it to the primary key. The facial recognition software loads the photo and creates a faceprint at 72. The database receives the faceprint from the facial recognition software, stores the faceprint at 74 and links the faceprint to the primary key. The first photo uploaded is given the name ME and is thus indicated as being a photo of the member. The member's computer then displays the uploaded profile together with a thumbnail of the uploaded photo at 76. The member is then prompted at 78 whether they wish to upload another photo. If they select yes, the process returns to 68 and the member is again presented with the dialog box of FIG. 3. Photos subsequent to the first upload require that member give the photos names. If the member selects no, the registration process ends at 80.

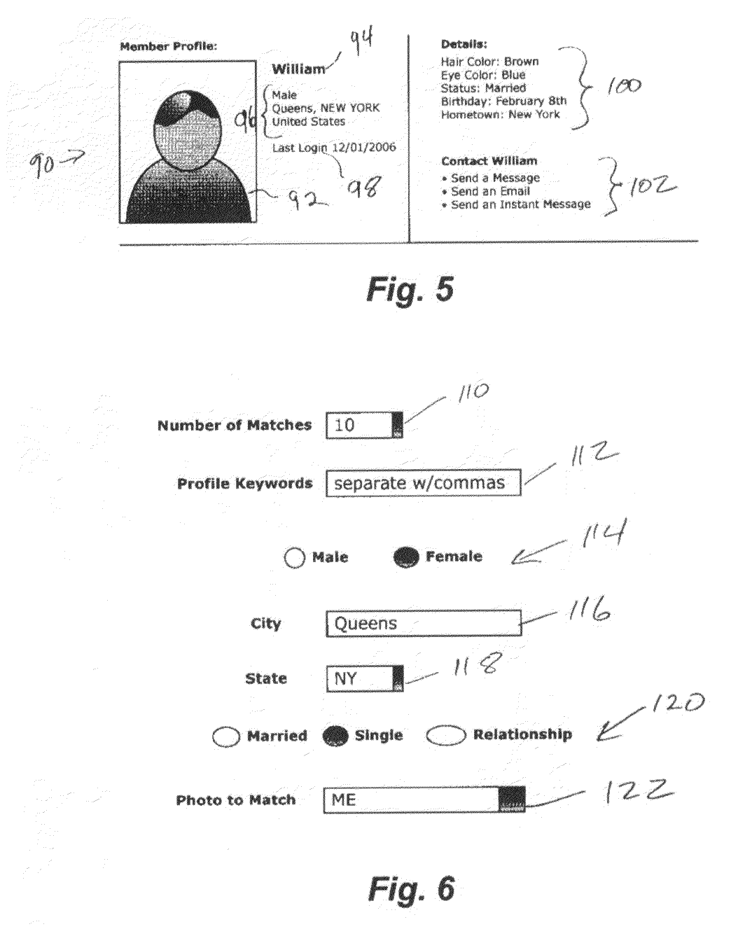

FIG. 5 illustrates a sample member profile 90. The profile includes a thumbnail photo 92, the member's first name 94, gender and geographical information 96, and last login date 98. Personal information 100 is also displayed together with contact links 102. The contact links illustrated include send a message which is system email, i.e. the message is delivered only when the member logs in. Instant message is also system based and is only available when the member is logged in. Send an email creates a message that is delivered to the member's email address which was entered upon registration (field 24 in FIG. 2).

Once registered, the next time the member types in the URL or selects the site from a bookmark, the member will be taken (by way of a cookie) to the login page rather than the register page. After being logged in, the member can then choose from a variety of menu options including “search member database”. Alternatively, members can select to be logged in automatically via a cookie.

FIG. 6 illustrates the interface for performing a search. First, the member selects the number of matches requested using the pull, down list 110. The default is ten matches. Profile keywords may be entered in the text field 112. Radio buttons 114 are used to select gender. City and state are entered at 116 and 118. Radio buttons 120 are used to specify the status of the members being searched. Lastly, at 122, the member selects which photo should be used in the search. The pull down list 122 will list all of the photos uploaded by the member at 68 in FIG. 4. Other criteria may be included in the search interface such as whether the member is currently logged in.

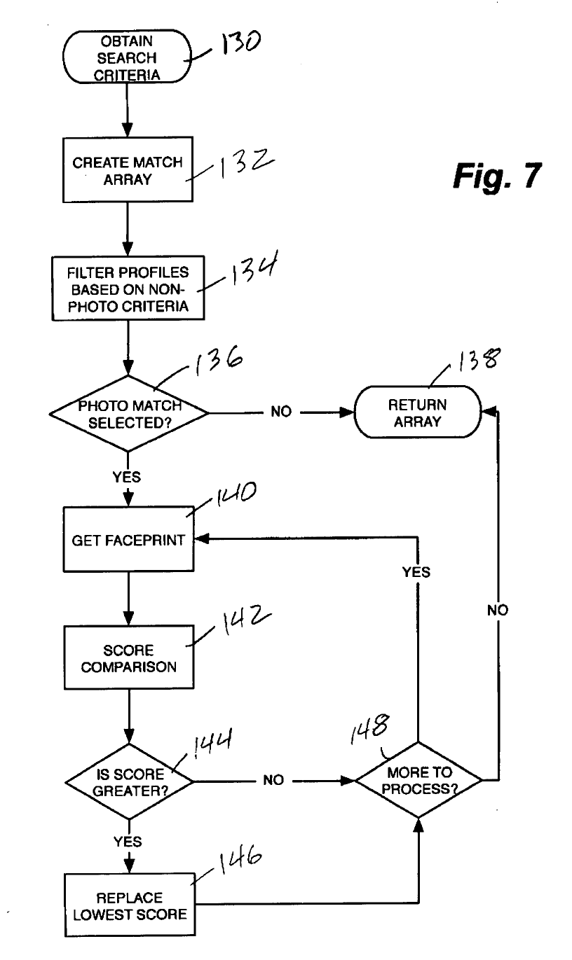

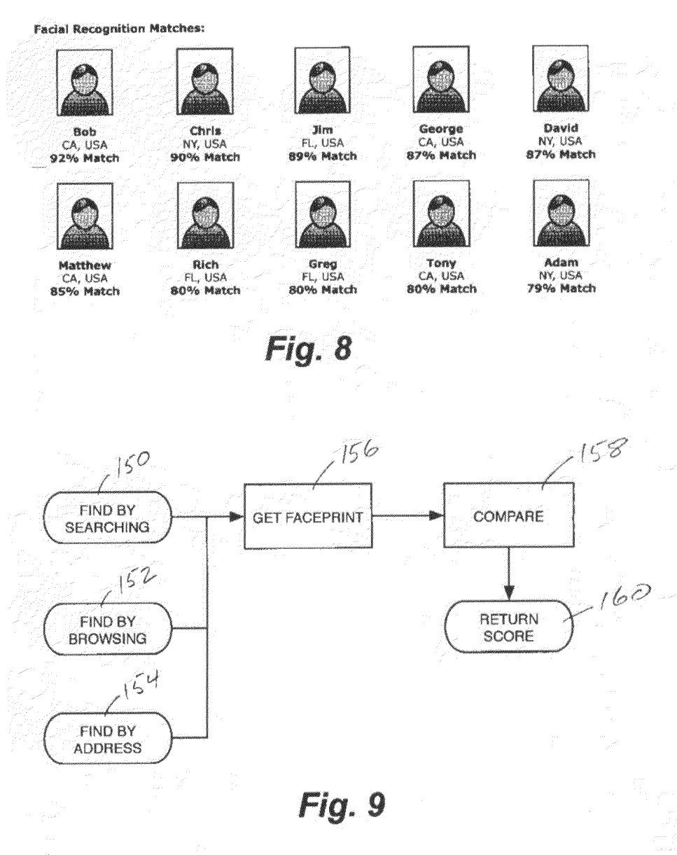

FIG. 7 illustrates the search process based on the search criteria entered using the interface of FIG. 6. The search criteria is obtained at 30 and an array based on the number of matches requested is created at 132. Member profiles are filtered based on the non-photo criteria (e.g. gender, status, etc.) at 134. It is then determined at 136 whether a photo match has been indicated. If no photo was specified, a matching array based on the non-photo criteria is returned at 138. If a photo match was indicated, faceprints are obtained at 140 and a comparison score is obtained at 142. At 144 it is determined whether the current faceprint has a matching score higher than the lowest scoring faceprint in the array. It will be appreciated that the first faceprint added to the array will always have a higher score. When the current faceprint scores higher than the lowest scoring faceprint in the array, the lowest scoring faceprint in the array is replaced with the current faceprint at 146. After processing the current faceprint it is determined at 148 whether more faceprints need to be processed. If there are more member profiles to process, the next faceprint is obtained at 140 and compared to the faceprint of the photo selected by the searching member at 142. The process continues until all of the member profiles which passed through the filter at 134 are faceprint matched and the array of profiles containing the top ten matching faceprints is created. An exemplary array is shown in FIG. 8 where the top ten matches range from a 92% match to a 79% match. Each of the array entries includes a thumbnail photo, member first name, and geographical information as well as the match score. The thumbnail photos are preferably hot linked to the member's full profile so that clicking on a thumbnail will bring up the member's profile, e.g. as shown in FIG. 5.

FIG. 9 illustrates three different ways for a first member to search for a second member based on a faceprint match. The first member may find by searching at 150 as described above with reference to FIGS. 6-8. Alternatively, the first member may search by browsing at 152 or may search by address at 154. In any case, faceprints are retrieved at 156, compared at 158 and scored at 160. The point of this is that in addition to searching for faceprint matches, members can search in traditional ways such as by profile keywords, location, age, gender, etc.

There have been described and illustrated herein systems and methods for connecting individuals in a social networking environment based on facial recognition software. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A social networking system, comprising:
means for associating each of a plurality of photographic images with an individual member's identity;
facial recognition means for establishing a faceprint corresponding to each of said photographic images;
means for comparing one member's faceprint to the faceprints of at least some of the other members; and
means for ranking match results of compared faceprints based at least in part on facial similarity.

2. A system according to claim 1, further comprising:
means for storing personal information about members.

3. A system according to claim 2, further comprising:
means for searching personal information about members.

4. A system according to claim 1, further comprising:
means for sending a message from one member to another.

5. A system according to claim 4, wherein:
said means for sending a message includes electronic mail and instant message.

6. A social networking method, comprising:
associating each of a plurality of photographic images with an individual member's identity;
establishing a faceprint corresponding to each of the photographic images;
comparing one member's faceprint to the faceprints of at least some of the other members; and
ranking match results of compared faceprints based at least in part on facial similarity.

7. A method according to claim 6, further comprising:
storing personal information about members.

8. A method according to claim 7, further comprising:
searching personal information about members.

9. A method according to claim 6, further comprising:
sending a message from one member to another.

10. A method according to claim 9, wherein:
the message is one of an electronic mail and instant message.

11. A social networking system, comprising:
means for associating each of a plurality of photographic images with an individual member's identity;
means for uploading one or more images for comparison;
facial recognition means for establishing a faceprint corresponding to each of said photographic images and each of said images for comparison;
means for comparing the faceprint of a selected image for comparison to the faceprints of at least some members; and
means for ranking match results of compared faceprints based at least in part on facial similarity.

12. A system according to claim 11, further comprising:
means for storing personal information about members.

13. A system according to claim 12, further comprising:
means for searching personal information about members.

14. A system according to claim 11, further comprising:
means for sending a message from one member to another.

15. A system according to claim 14, wherein:
said means for sending a message includes electronic mail and instant message.

16. A social networking method, comprising:
associating each of a plurality of photographic images with an individual member's identity;
uploading one or more images for comparison;
establishing a faceprint corresponding to each of the photographic images and each of the images for comparison;
comparing the faceprint of a selected image for comparison to the faceprints of at least some of the members; and
ranking match results of compared faceprints based at least in part on facial similarity.

17. A method according to claim 6, further comprising:
storing personal information about members.

18. A method according to claim 7, further comprising:
searching personal information about members.

19. A method according to claim 6, further comprising:
sending a message from one member to another.

20. A method according to claim 9, wherein:
the message is one of an electronic mail and instant message.
